(19) United States
(12) Patent Application Publication
(10) Pub. No.: US 2005/0241323 A1
(43) Pub. Date: Nov. 3, 2005

(54) Energy analyzer for a refrigeration system

(76) Inventors: Wanda Jean Miller, Harrisburg, PA (US); Roy Samuel Hubbard JR., York, PA (US); Jeffrey Daniel Boyer, York, PA (US)

Correspondence Address: MCNEES, WALLACE & NURICK LLC, 100 PINE STREET, P.O. BOX 1166, HARRISBURG, PA, 17108-1166, US

(21) Appl. No.: 10/819,850

(22) Filed: Apr. 7, 2004

(51) Int. Cl. G01K 13/00; G05D 23/32; F25D 9/00

(52) U.S. Cl. 62/129; 62/157

(57) ABSTRACT

An energy analyzer for a refrigeration system including a refrigeration circuit having a compressor, a condenser and an evaporator, and a variable speed drive. A device contains an equation correlating refrigeration system operating performance using a variable speed drive to that of a constant speed drive without requiring the constant speed drive. The equation defines a polynomial expression having different combinations of two variables, the temperature of water entering the condenser, and the ratio defined by the variable speed drive input power divided by the design variable speed drive power. Each of these values is continuously calculated during operation of the refrigeration system. The equation solution correlates to the constant speed input power divided by the design constant speed drive power. From this, energy costs associated with operation of the refrigeration system using the constant speed drive can then be calculated with that of the variable speed drive.

### FIELD OF THE INVENTION

The present invention relates generally to an energy analyzer, and more particularly to an energy analyzer for use with a refrigeration system incorporating a VSD to estimate the operating cost savings of the VSD when compared to a refrigeration system incorporating a fixed or constant speed drive.

### BACKGROUND OF THE INVENTION

Until relatively recently, refrigerant systems, such as a chiller system, were driven by compressors that operated at a substantially constant speed to compress refrigerant vapor for circulation in a refrigerant circuit including a condenser and an evaporator to provide cooling to an interior space. A chiller system's performance is designed to achieve a rated capacity at a rated head while expending a predetermined amount of energy. For example, a chiller system having a rated 400 ton cooling capacity at a rated 85° F. entering condenser water temperature (“ECWT”) would be able to achieve 400 tons of cooling at a predetermined energy rate, such as 250 kW. By operating the compressor at a constant speed using a constant speed drive (“CSD”), the compressor expends more energy than required to satisfy the cooling load and head when the cooling load and head is less than the rated capacity of the compressor. The amount of wasted energy resulting from lower cooling loads and lower heads can be substantial.

The introduction of variable speed drives (“VSDs”) to drive compressor motors permits the compressor motors to be operated at variable speeds in response to variable cooling loads and variable cooling heads. For example, in response to a reduced cooling load, the VSD reduces the operating speed of the compressor motor, likewise reducing the cooling provided by the refrigerant system to satisfy the reduced cooling load. Reducing the operating speed of the compressor motor reduces the amount of energy required to operate the compressor, resulting in an energy savings. These savings may be significant, typically requiring only a few years of operation for the energy savings to pay for the cost of installing a VSD to replace the existing CSD in a refrigerant system.

One way to encourage owners of refrigerant systems to install VSDs is for an installer to form an arrangement with the owner wherein the VSD is installed on the owner's refrigerant system at little or no cost to the owner. The installer would be provided a percentage of cost savings realized by operation of the refrigerant system for a predetermined time period to recoup the cost of the VSD and its installation. However, calculation of the cost savings is not easily accomplished. First of all, because the CSD has been removed, the direct means to measure the energy costs associated with operation of the CSD no longer exists. Second, because speed of the compressor motor the VSD, as its name implies, is constantly changing, the operation of the VSD does not lend itself to comparing the costs associated with operating the CSD versus the VSD.

Thus, there is a need for a process for accurately comparing, calculating and displaying the difference between the costs associated with the operation of a CSD and a VSD in a refrigeration system while the refrigeration system is using only a VSD.

### SUMMARY OF THE INVENTION

The present invention relates to a method for comparing costs associated with operating a refrigeration system using a variable speed drive versus a constant speed drive while the refrigeration system is operating with the variable speed drive. The steps include providing an equation correlating operating performance of a refrigeration system using a variable speed drive versus a refrigeration system using a constant speed drive; inputting values associated with operation of the refrigeration system; measuring a parameter associated with the equation; determining an amount of energy required by the variable speed drive to operate the refrigeration system for a predetermined time; calculating a ratio based on the amount of energy required by the variable speed drive divided by a predetermined amount of energy required for the variable speed drive; calculating a cost associated with operation of the refrigeration system using the variable speed drive; calculating a cost associated with operation of the refrigeration system using the constant speed drive using the equation; and comparing the cost associated with operating the refrigeration system using the variable speed drive with the cost associated with operating the refrigeration system using the constant speed drive.

The present invention further relates to a refrigeration system including a refrigeration circuit having a compressor driven by a motor, a condenser and an evaporator connected in a closed loop. A variable speed drive is for use with the compressor motor; and a device storing an equation correlating operating performance of a refrigeration system using a variable speed drive versus a constant speed drive. At least one sensor measures a parameter associated with the equation. Wherein upon the device measuring an amount of energy required by the variable speed drive using the refrigeration system for a predetermined time, calculating a first cost associated with operating the refrigeration circuit using the variable speed drive, and calculating a first ratio based on the amount of energy required by the variable speed drive divided by a predetermined amount of energy required by the variable speed drive, the device solves the equation using the first ratio and the parameter to obtain a second ratio being based on the amount of energy required by the constant speed drive divided by a predetermined amount of energy required by the constant speed drive. The device calculates a cost associated with operation of the refrigeration system using the constant speed drive.

Among the principal advantages of the present invention is the ability to compare energy savings between operating a refrigeration system with a VSD as opposed to a CSD without the need for a CSD operated refrigeration system.

Another advantage of the present invention is the ability to compare energy savings between operating a refrigeration system with a VSD as opposed to a CSD without having to manipulate a family of performance curves associated the CSD.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a schematic view of a refrigerant system for use with a device of the present invention.

FIG. 2 shows a set of actual performance curves for multiple capacity refrigeration systems using R134a refrigerant, using a CSD and having an entering condenser water temperature of 65° F.

FIG. 3 shows a set of actual performance curves for the multiple capacity refrigeration systems using R134a refrigerant, using a VSD and having an entering condenser water temperature of 65° F.

FIG. 4 shows a set of curve-fitted performance curves for the refrigeration system using R134a refrigerant, using the CSD and having an entering condenser water temperatures of 45-95° F.

FIG. 5 shows a set of curve-fitted performance curves for the refrigeration system using R134a refrigerant, using the VSD and having an entering condenser water temperatures of 45-95° F.

FIG. 6 shows the curve-fitted performance curve for the refrigeration system using the CSD being overlaid by the refrigeration system using the VSD, using R134a refrigerant and having an entering condenser water temperature of 65° F.

FIG. 7 shows a set of actual performance curves for multiple capacity refrigeration systems using R123 refrigerant, using a CSD and having an entering condenser water temperature of 65° C.

FIG. 8 shows a set of actual performance curves for the multiple capacity refrigeration systems using R123 refrigerant, using a VSD and having an entering condenser water temperature of 65° F.

FIG. 9 shows a set of curve-fitted performance curves for the refrigeration system using R123 refrigerant, using the CSD and having entering condenser water temperatures of 45-95° F.

FIG. 10 shows a set of curve-fitted performance curves for the refrigeration system using R123 refrigerant, using the VSD and having entering condenser water temperatures of 45-95° F.

FIG. 11 shows the curve-fitted performance curve for the refrigeration system using the CSD being overlaid by the refrigeration system using the VSD, using R123 refrigerant and having an entering condenser water temperature of 65° F.

FIG. 12 shows a flow chart for comparing costs of the refrigeration system using the CSD versus the VSD for a process of the present invention.

Wherever possible, the same reference numbers will be used throughout the drawings to refer to the same or like parts.

### DETAILED DESCRIPTION OF THE INVENTION

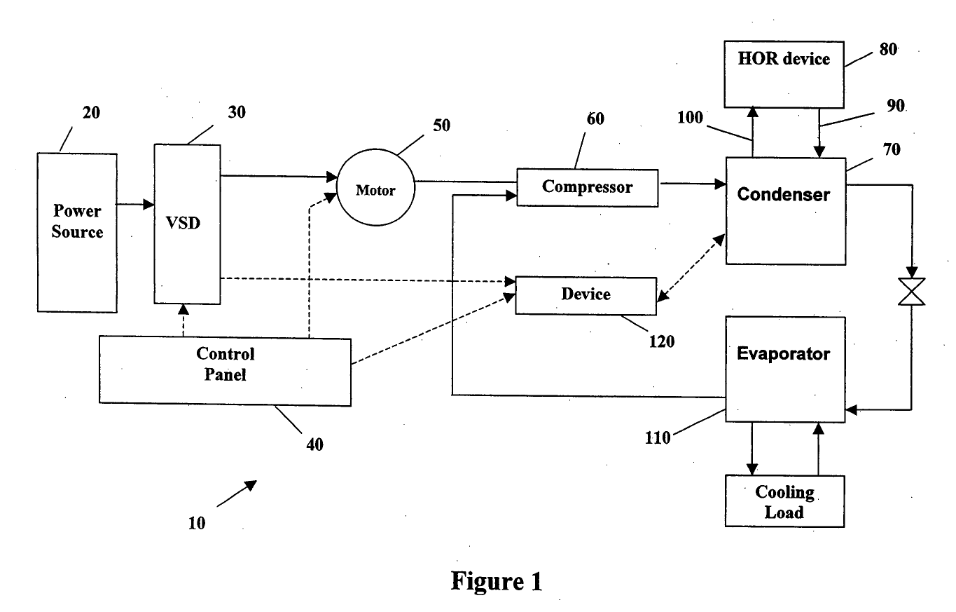

FIG. 1 illustrates generally an application of the present invention. An AC power source 20 supplies a variable speed drive (VSD) 30, which powers a motor 50. In another embodiment, the VSD 30 can power more than one motor 50 or each of multiple VSDs 30 or VSD sections may be used to power corresponding motors 50. The motor 50 is preferably used to drive a corresponding compressor 60 of a refrigeration or chiller system 10.

The AC power source 20 provides single phase or multi-phase (e.g., three phase), fixed voltage, and fixed frequency AC power to the VSD 30 from an AC power grid or distribution system that is present at a site. The AC power source 20 preferably can supply an AC voltage or line voltage of 200 V, 230 V, 380 V, 460 V, or 600 V at a line frequency of 50 Hz or 60 Hz to the VSD 30, depending on the corresponding AC power grid.

The VSD 30 receives AC power having a particular fixed line voltage and fixed line frequency from the AC power source 20 and provides AC power to the motor 50 at desired voltages and desired frequencies, both of which can be varied proportionally to satisfy particular requirements. Preferably, the VSD 30 can provide AC power to the motor 50 that may have higher voltages and frequencies and lower voltages and frequencies than the rated voltage and frequency of the motor 50. In another embodiment, the VSD 30 may again provide higher and lower frequencies but only the same or lower voltages than the rated voltage and frequency of the motor 50.

A microprocessor, controller or control panel 40 is used to control the VSD 30, motor 50 and a device 120 that may be used to analyze and compare the costs associated with operating the refrigeration system using the VSD 30 as opposed to using a CSD (not shown). Specifically, the device 120 permits such cost comparison without the presence of the CSD as will be discussed in further detail below.

The control panel 40 executes a control system that uses control algorithm(s) or software to control operation of the refrigeration system 10 and to determine and implement an operating configuration to control the capacity of the compressor 60 in response to a particular output capacity requirement for the refrigeration system 10. In one embodiment, the control algorithm(s) can be computer programs or software stored in the non-volatile memory of the control panel 40 and can include a series of instructions executable by the microprocessor of the control panel 40. While it is preferred that the control algorithm be embodied in a computer program(s) and executed by the microprocessor, it is to be understood that the control algorithm may be implemented and executed using digital and/or analog hardware by those skilled in the art.

The motor 50 is preferably an induction motor that is capable of being operated at variable speeds. The induction motor can have any suitable pole arrangement including two poles, four poles or six poles. However, any suitable motor that can be operated at variable speeds can be used with the present invention.

Preferably, the control panel, microprocessor or controller 40 can provide control signals to the VSD 30 to control the operation of the VSD 30, and particularly the operation of the motor 50 to provide the optimal operational setting for the VSD 30 and motor 50 depending on the particular sensor readings received by the control panel 40. For example, in the refrigeration system 10, the control panel 40 can adjust the output voltage and frequency provided by the VSD 30 to correspond to changing conditions in the refrigeration system 10, i.e., the control panel 40 can increase or decrease the output voltage and frequency provided by the VSD 30 in response to increasing or decreasing load/head conditions on the compressor 60 in order to obtain a desired operating speed of the motor 50 and a desired capacity of the compressor 60. A conventional HVAC, refrigeration or liquid chiller system 10 includes many other features that are not shown in FIG. 1. These features have been purposely omitted to simplify the drawing for ease of illustration.

The refrigeration system 10 further includes a condenser arrangement 70, an HOR device 80, such as a reservoir, having a supply line 90 that supplies water to the condenser 70 and a return line 100 that returns water to the HOR device 80, expansion devices, a water chiller or evaporator arrangement 110. The control panel 40 can include an analog to digital (A/D) converter, a microprocessor, a non-volatile memory, and an interface board to control operation of the refrigeration system 10. The control panel 40 can also be used to control the operation of the VSD 30, the motor 50 and the compressor 60. The compressor 60 compresses a refrigerant vapor and delivers it to the condenser 70.

The compressor 60 is preferably a screw compressor or a centrifugal compressor, however the compressor can be any suitable type of compressor including a reciprocating compressor, scroll compressor, rotary compressor or other type of compressor. The coefficients of best fit curves are compressor type and refrigerant dependent, although the relationship remains the same (see equations [1] and [2] below). The output capacity of the compressors 60 can be based on the operating speed of the compressor 60, which operating speed is dependent on the output speed of the motor 50 driven by the VSD 30. The refrigerant vapor delivered to the condenser 70 enters into a heat exchange relationship with a fluid, such as water, although it may be possible to use air, and undergoes a phase change to a refrigerant liquid as a result of the heat exchange relationship with the liquid. The condensed liquid refrigerant from condenser 70 flows through corresponding expansion devices to the evaporator 10.

The evaporator 110 can include connections for a supply line and a return line of a cooling load. A secondary liquid, which is preferably water, but can be any other suitable secondary liquid, e.g., ethylene glycol, propylene glycol, calcium chloride brine or sodium chloride brine, travels into the evaporator 110 via a return line and exits the evaporator 110 via a supply line. The liquid refrigerant in the evaporator 110 enters into a heat exchange relationship with the secondary liquid to chill the temperature of the secondary liquid. The refrigerant liquid in the evaporator 110 undergoes a phase change to a refrigerant vapor as a result of the heat exchange relationship with the secondary liquid. The vapor refrigerant in the evaporator 10 then returns to the compressor 60 to complete the cycle. It is to be understood that any suitable configuration of condenser 70 and evaporator 110 can be used in the system 10, provided that the appropriate phase change of the refrigerant in the condenser 70 and evaporator 10 is obtained.

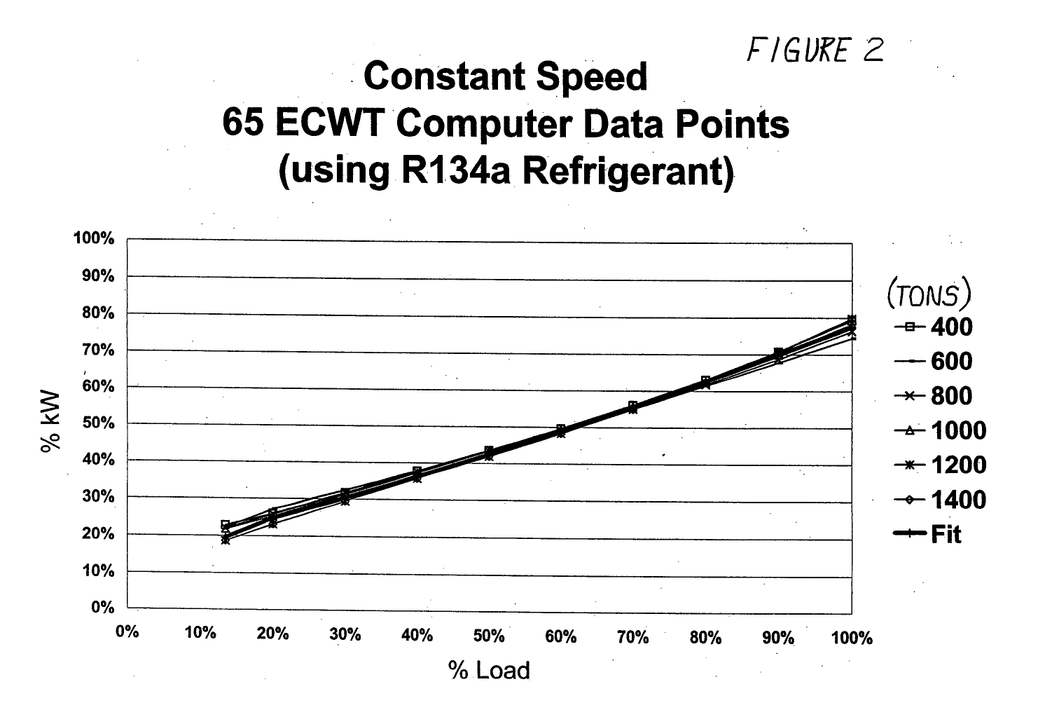

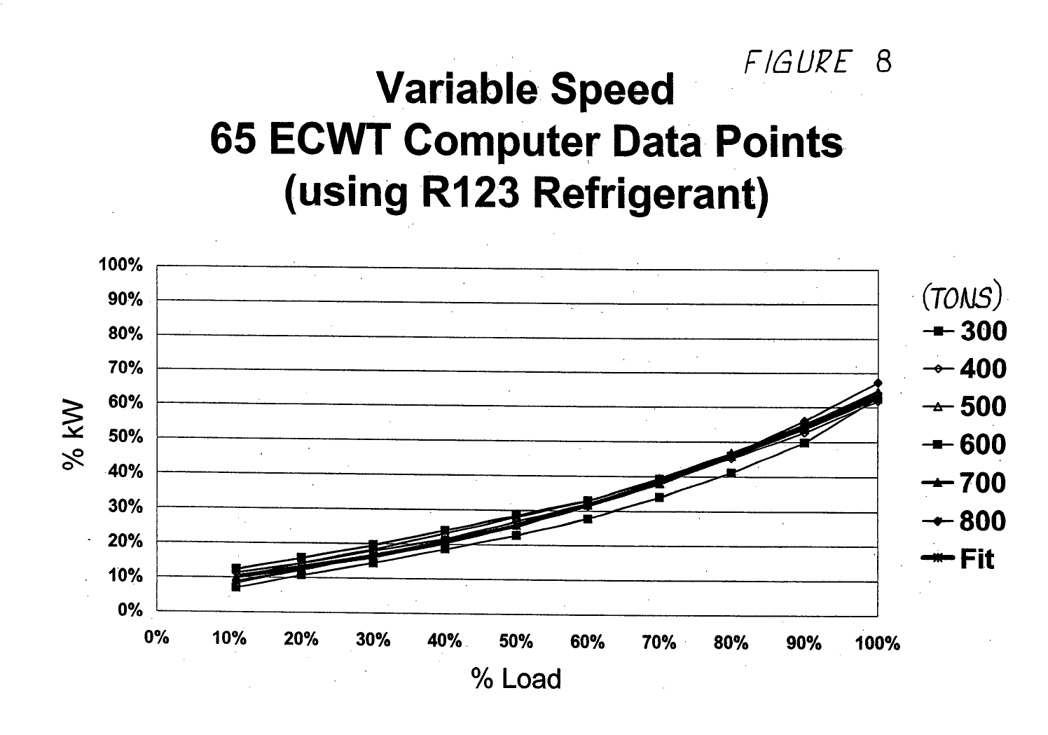

The present invention includes an equation that can correlate operating performance of the refrigeration system 10 with the VSD 30 versus a CSD. The equation of the present invention is derived from Air-Conditioning and Refrigeration Institute (ARI) programs which are certified to accurately correspond to the operating performance of the refrigeration system that it represents. However, the equation of the present invention makes use of a single “best fit” curve generated from multiple curves (as FIGS. 2, 3 and 7, 8 illustrate) for operation of a refrigeration system using a VSD, each curve representing a selected constant head. Similarly, a single “best fit” curve is generated from multiple curves for operation of a refrigeration system using a CSD. Each “best fit” curve corresponds to operation of the refrigeration curve with a cooling fluid, such as water, entering the condenser 70 from the supply line 90 at a given temperature. Once the refrigeration system is operated using the VSD 30, the load percentage (% load) can be determined. The % load is a ratio of the amount of cooling provided by the refrigeration system divided by the design capacity of the refrigeration system. For example, if the refrigeration system has a design capacity of 400 tons of cooling and is operating to provide 200 tons, the % load is 50%. Since the % load for corresponding CSD and VSD curves is identical at the time of comparison, the curves can be overlaid. By correlating the overlaid best fit curves, which define a nomogram, having a common x-axis intercept value (% load), the y-axis intercepts (% kW) can be compared, as can the operating costs.

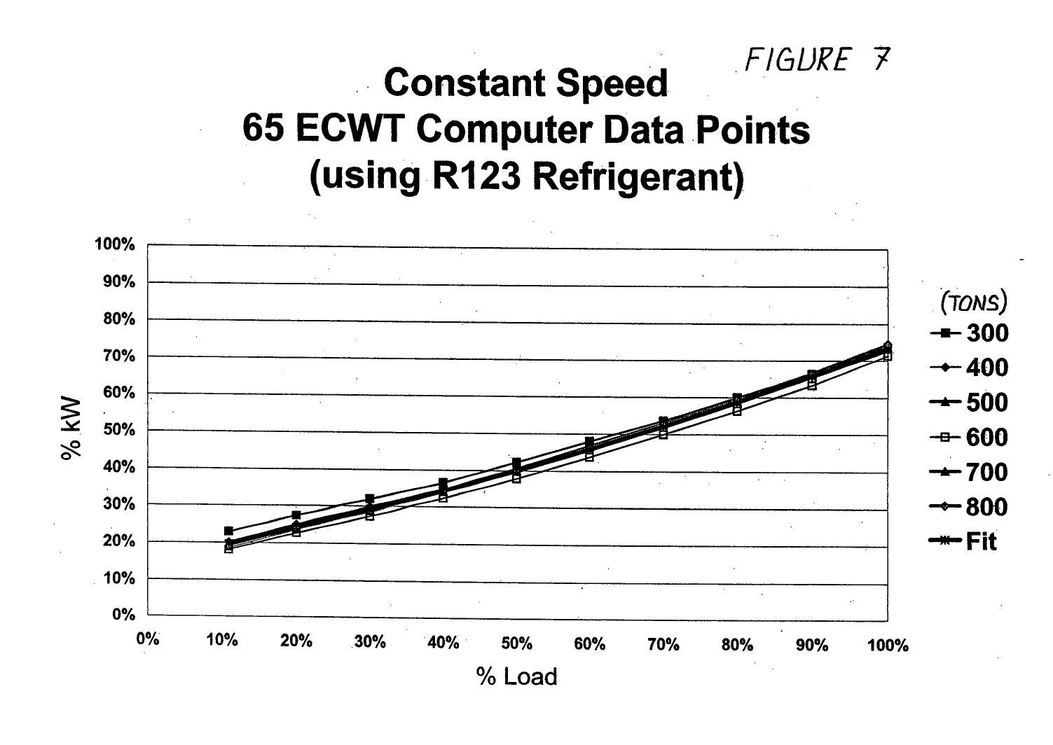

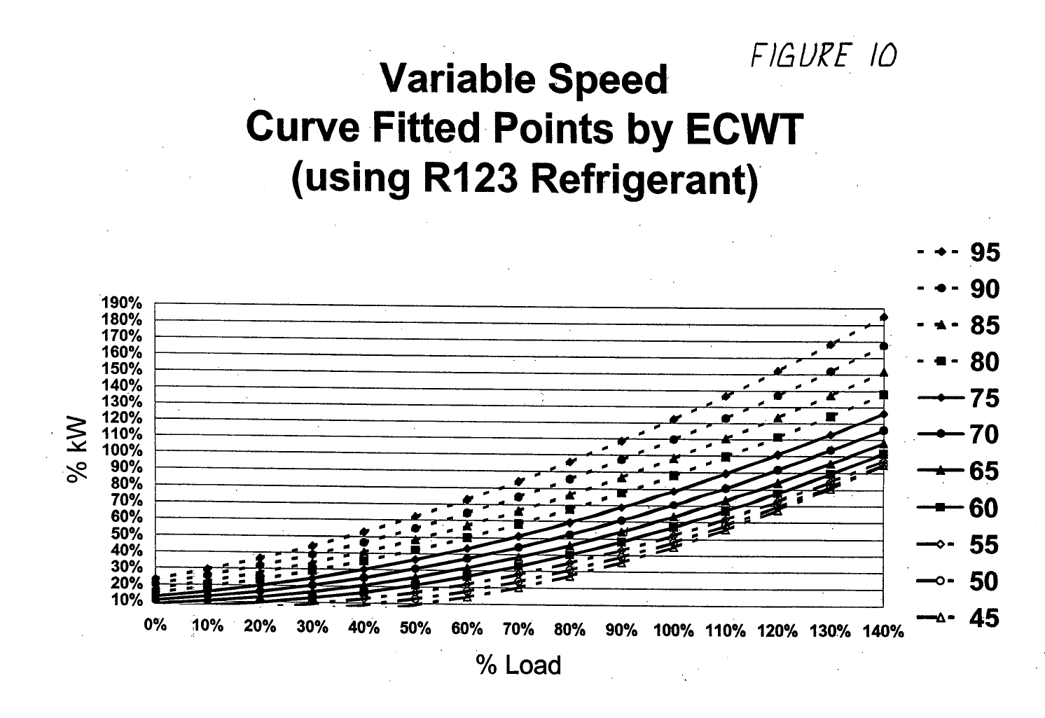

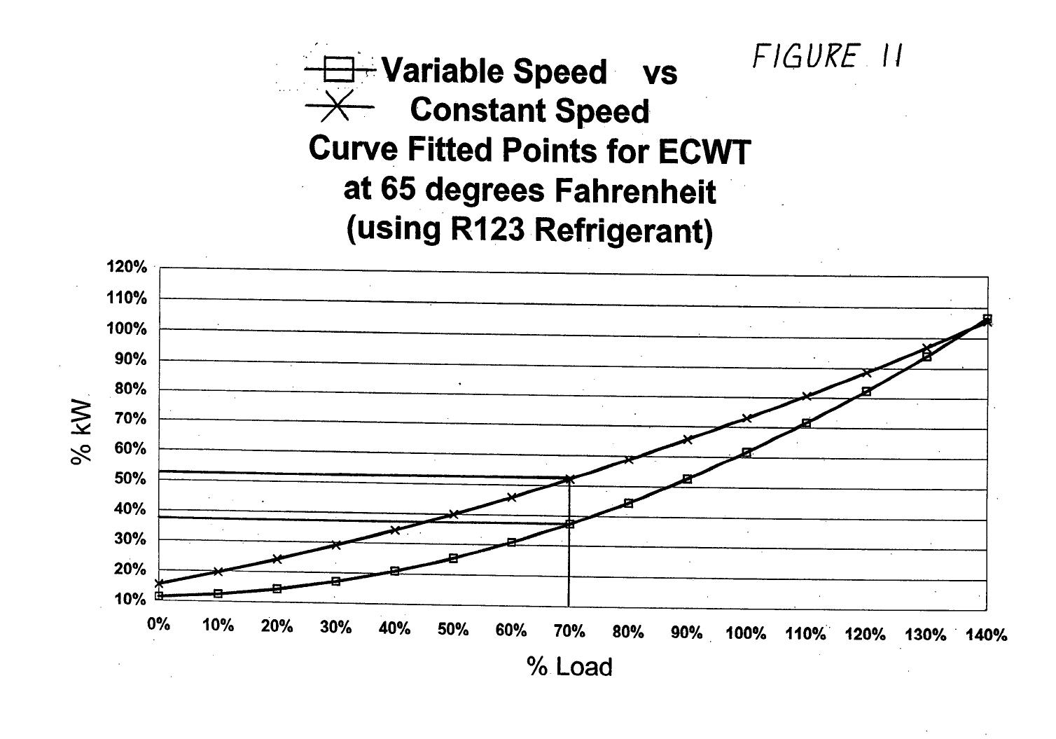

Two equations of the present invention have been derived, one from a refrigeration system using R134a refrigerant (FIGS. 2-6), and the other from a refrigeration system using R123 refrigerant (FIGS. 7-11). Since each equation is derived in the same way, only FIGS. 2-6 will be discussed in detail. Each derived equation is a nine term polynomial expression including the same combinations of two parameters that are discussed in further detail below.

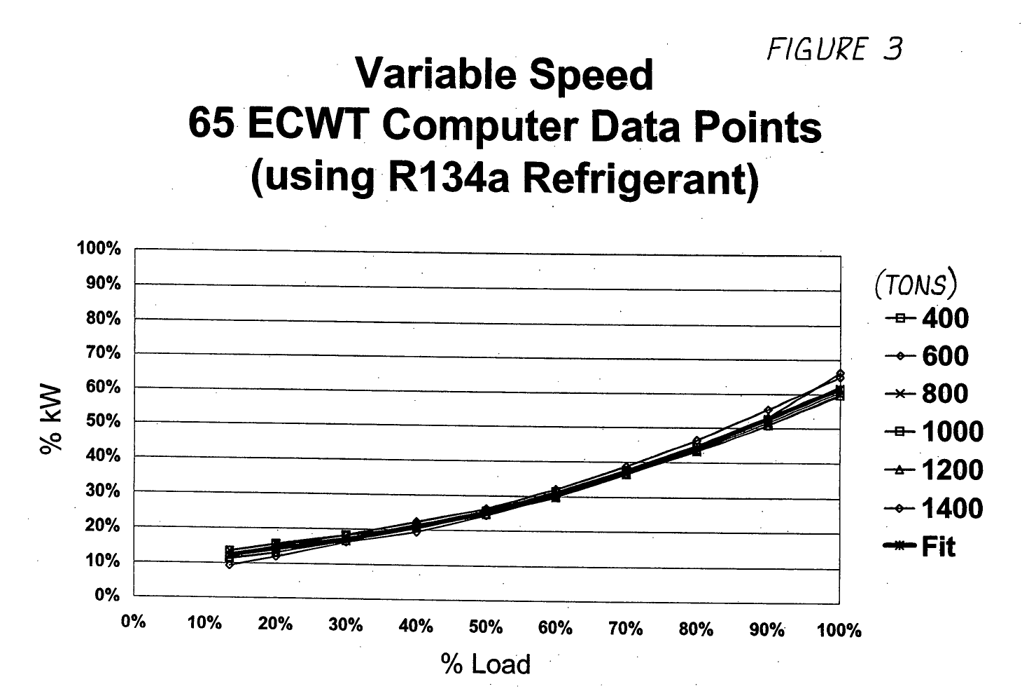

FIG. 2 shows performance curves for a refrigeration system using a CSD, using R134a refrigerant, and having an entering condenser water temperature (“ECWT”) of 65° F. (see supply line 90 in FIG. 1). Each curve corresponds to a refrigeration system having a different cooling capacity, expressed in tons, a ton being equal to 12,000 BTUs. There are six different cooling capacity curves, corresponding to 400-1,400 tons in 200 ton increments. A seventh curve is a best fit curve, which was calculated from a curve-fitting program that most closely corresponded to the six cooling capacity curves. FIG. 3 measured the same data as was measured in FIG. 2, except FIG. 3 corresponds to performance curves for the refrigeration system using a VSD. However, head can also be measured as leaving condenser water temperature (“LCWT”), saturated condensing temperature, refrigerant pressure or temperature differential between the evaporator and condenser as are well known in the art. These different head measurements can be incorporated by changing the coefficients of the relationship (see equations [1] and [2] below).

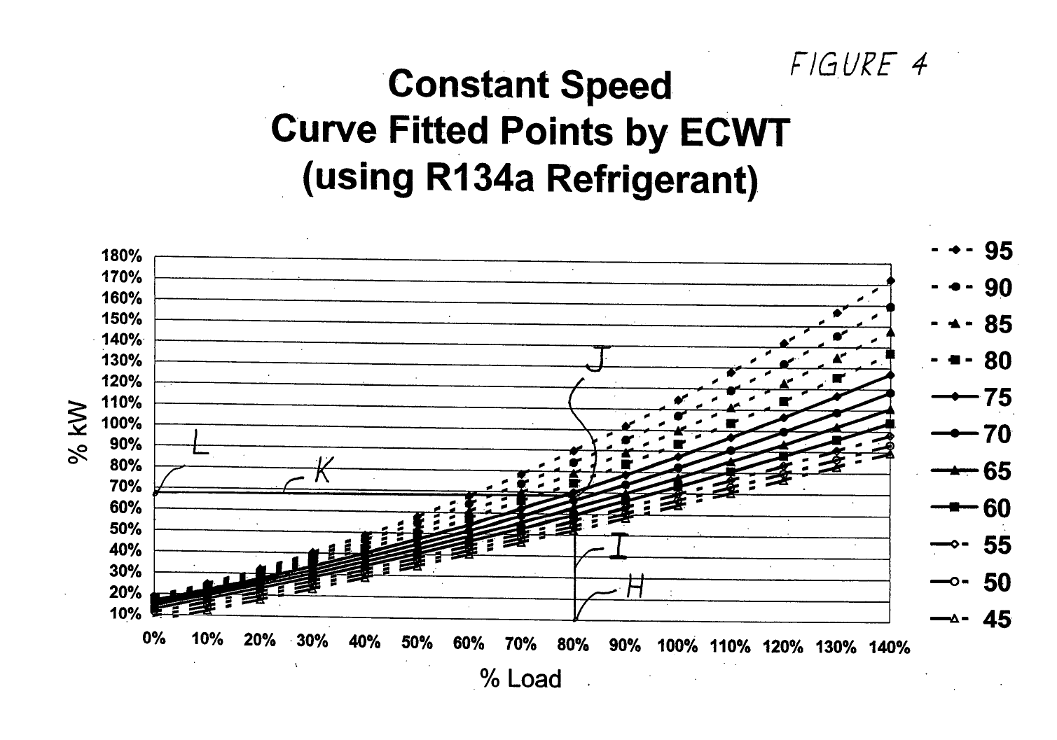

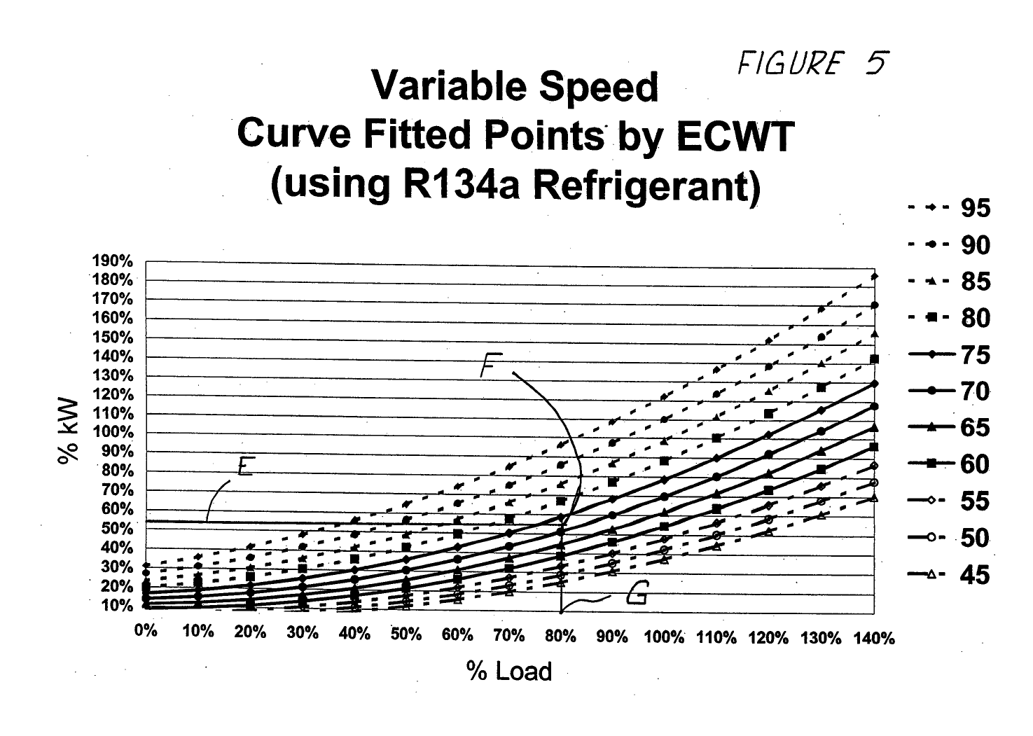

A similar set of performance curves was generated for each ECWT increment of 5° F. for a range of 45° F.-95° F. FIG. 4 shows the performance curves for the refrigeration system using the CSD at different ECWTs ranging from 45-95° F. in 5 degree increments. Similarly, FIG. 5 shows the performance curves for the refrigeration system using the VSD at different ECWTs ranging from 45-95° F. in 5 degree increments.

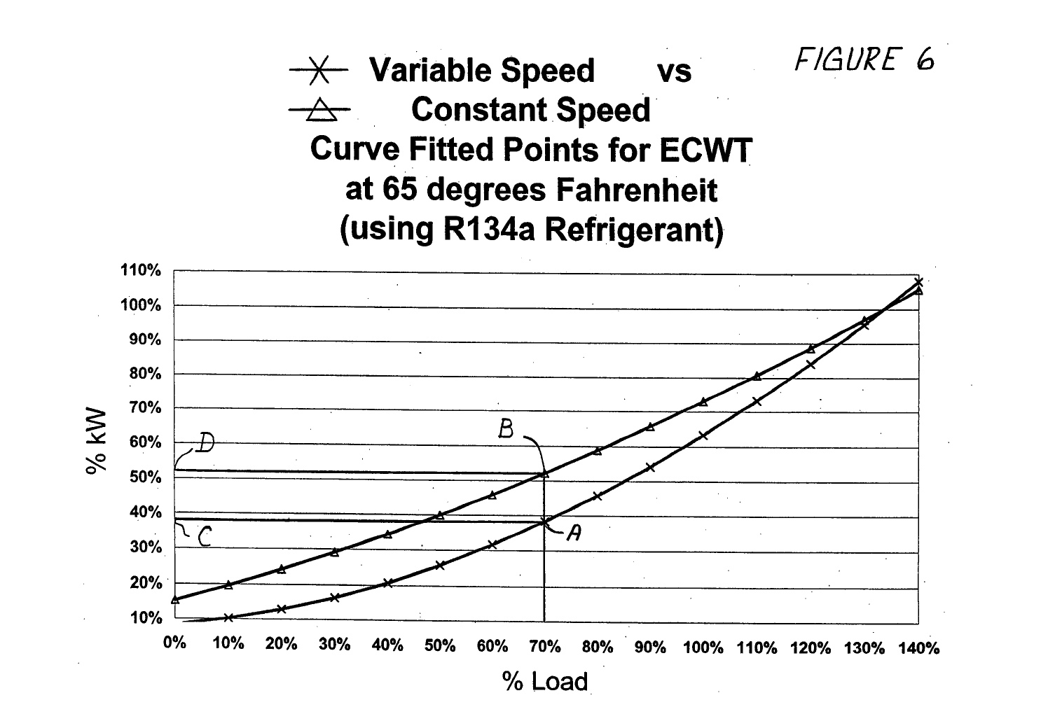

FIG. 6 contains both the performance curves for the refrigeration system using the CSD and the VSD for ECWT of 65° F. Although the curves are different from each other, the curves share a common cooling load at a particular time to which they are applied. For example, if the refrigeration system is a 500 ton unit, and the particular cooling load is 350 tons, the % load is 70%. A vertical x-intercept line can be drawn from the 70% load to intersect each of the curves, point A for the VSD curve, and point B for the CSD curve. Similarly, a horizontal line can then be drawn from the point A of the VSD curve to define a y-intercept point C, and a horizontal line can then be drawn from the point B of the CSD curve to define a y-intercept point D. Each of the points C and D correspond to a % kW reading, which is a percentage of the energy expended as compared to the energy expended at 100% load, or the design load. The amount of energy expended at the design load is the design kW. Since the design load is based on a rated motor speed and a voltage provided to the motor, if the motor speed exceeds the rated motor speed, both the % load and the % kW can exceed 100%, or the design load and the design kW, as is shown by a portion of the curves in the upper right hand portion in FIG. 6.

To calculate energy costs, each of the % kW readings for the respective speed drive is multiplied by its respective design kW to obtain a kW value. Each of the calculated kW values is then subtracted from each other to obtain a difference kW which is the difference between points C and D on the % load (y-axis) after being multiplied by the respective design kW. However, energy consumption is typically expressed in kW-hrs. Therefore, once the difference kW is calculated, the difference is then multiplied by the amount of time that the difference kW occurred, and then further multiplied by the rate that is charged for energy, such as $0.06 per kW-hr.

As previously stated, FIGS. 2-6 and FIGS. 7-11 correspond to refrigeration system performance curves, and are formulated the same way, although the refrigeration system in FIGS. 7-11 uses a different refrigerant, R123 (or R11), versus R134a (or R22) in FIGS. 2-6, and the cooling capacities in the R123 refrigerant system was from 300-800 tons, versus 400-1,400 tons in the R134a refrigerant system.

By combining the curve-fitted points to obtain a single curve for each 5° F. increment of ECWT, such as in FIG. 2, exact values are no longer obtained. That is, the fit curve of FIG. 2 does not exactly match the curves for any of the head-capacity curves in FIG. 2. However, since the curves substantially overlay each other, the best fit approximations are quite close, the values being typically within about 5 percent of any selected head-capacity. The best fit approximation removes the requirement for a significant amount of data that would otherwise need to be retained to perform these calculations. While this best fit approximation is a greatly simplified approach, it still requires maintaining performance curves for each 5° F. increment of ECWT for both the CSDs and the VSDs, and performing numerous calculations to determine the % kW ratios, as discussed in FIG. 6.

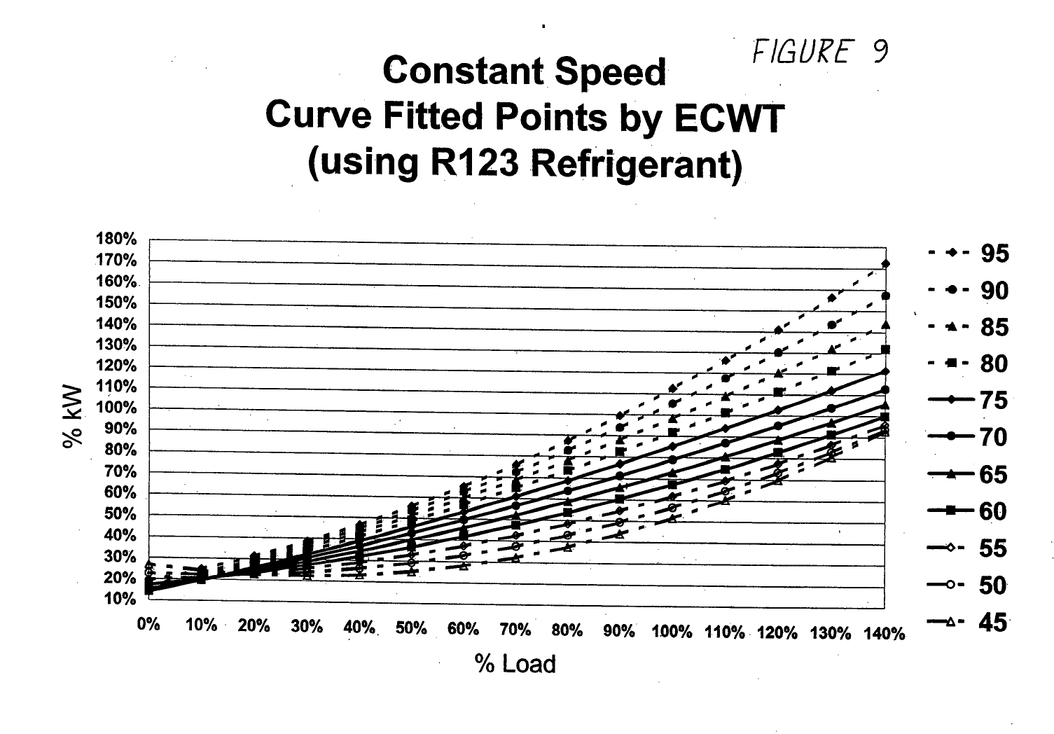

To avoid the curve manipulation and associated calculations, an equation was derived for each of the two refrigeration systems in respective FIGS. 4 and 9 using the best fit curve data for each of the 5° F. increments of ECWT to obtain a ratio of the CSD input to the CSD design kW, identified as “D”. The equations, although having different coefficients, each define a 9 term polynomial expression based on various combinations of two terms. The first term “X”, is the ratio of VSD input kW to VSD design kW, ranging in value from 0.00 to 1.00. The second term “Y”, is the ECWT, measured in degrees Fahrenheit (° F.). Equation 1 is derived from data extracted from the curves in FIG. 4, and equation 2 is derived from data extracted from the curves in FIG. 9.

$$\begin{matrix}\begin{matrix}D = ( 2.348 e - 2 ) + \\ ( 4.277 ) \times X + \\ ( - 8.209 ) \times {X}^{2} + \\ ( 4.105 e - 3 ) \times Y + \\ ( - 4.735 e - 2 ) \times X \times Y + \\ ( 1.641 e - 1 ) \times {X}^{2} \times Y + \\ ( - 6.694 e - 5 ) \times {Y}^{2} + \\ ( 1.621 e - 4 ) \times X \times {Y}^{2} + \\ ( - 8.363 e - 4 ) \times {X}^{2} \times {Y}^{2}\end{matrix} & [ 1 ] \\ \begin{matrix}D = ( 2.188 ) + \\ ( - 1.186 e + 1 ) \times X + \\ ( 1.331 e + 1 ) \times {X}^{2} + \\ ( - 5.139 e - 2 ) \times Y + \\ ( 3.526 e - 1 ) \times X \times Y + \\ ( - 3.714 e - 1 ) \times {X}^{2} \times Y + \\ ( 2.957 e - 4 ) \times {Y}^{2} + \\ ( - 2.338 e - 3 ) \times X \times {Y}^{2} + \\ ( 2.504 e - 3 ) \times {X}^{2} \times {Y}^{2}\end{matrix} & [ 2 ]\end{matrix}$$

These equations permit the comparison of energy costs of the refrigeration system using the CSD with the measured energy costs of the refrigeration using the VSD without requiring the performance curves for the refrigeration system for either of the drives.

To calculate a cost savings for the refrigeration system 10 using the VSD 30 versus using the CSD by applying the equation, both the VSD design kW and the CSD design kW must be provided, as must the cost per kW-hr and the ECWT. In an example, for an 800 ton refrigeration system using R134a refrigerant, the design kW for the VSD was 530 kW and the design kW for the CSD was 508 kW, and the input VSD was 285 kW. The ECWT was 72° F. Therefore the “X” term (input variable speed kW/VSD design kW) was 285 kW divided by 530 kW, or about 0.54. The “Y” term is 72. Substituting these values into equation [1] yields a value for “D” of about 0.68, which is the ratio of CSD input kW (“Z”) divided by the CSD design kW (D=0.68=Z/508). This yields a value for the CSD input kW of 345 kW.

To double-check the results from the equation against the graphical data, refer to FIG. 5, which is the variable speed curve using R134a refrigerant. Line “E” is the y-intercept extending from 0.54 (54%) horizontally to point “F”. Point “F” is an interpolation between the 70° F. and 75° F. ECWT curves, since the ECWT was 72° F. Tracing a vertical line from point “F” to the x-intercept, point “G”, yields approximately an 80% load. Refer now to FIG. 4, which is the constant speed curve using R134a. Starting with the 80% load, point “H”, a vertical line “I” is traced to point “J”, which is also an interpolation between the 70° F. and 75° F. ECWT curves, since the ECWT was 72° F. Tracing a line “K” from point “J” to y-intercept, point “L”, is 0.68, which matches the ratio calculated for D above. Therefore, this example confirms that equation [1] defines the relationship between the performance of the CSD and the VSD for the refrigeration system.

To then calculate the actual costs savings, assuming, for convenience, the values were maintained for one hour, with an energy cost of $0.06 per kW-hr, the difference in kW between the refrigeration system using the VSD and the CSD is 60 kW (345-285 kW). The savings for one hour under these conditions is then $3.60 ($0.06×60).

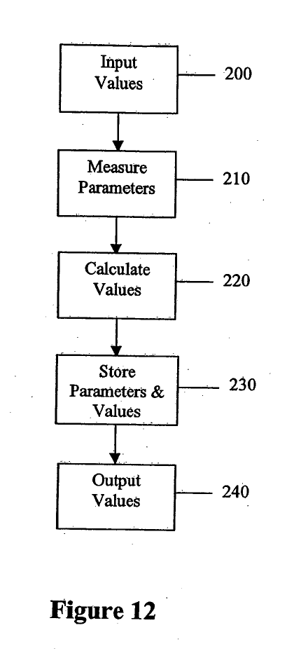

FIG. 12 illustrates a flow chart detailing the control process of the present invention relating to cost comparison in a refrigeration system 10 as shown in FIG. 1, wherein the device 120 is in data communication with the control panel 40. The process begins in step 200 with inputting values into device 120, such as the price per kW-hr, the variable speed design kW, the constant speed design kW and setting the display screen of the device 120. The variable speed design kW and the constant speed design kW are values set by the manufacturers at the time of commission of refrigeration system, and are intended to be input by the installers of the device 120. The price per kW-hr can be updated as required. The display screen of the device 120 is typically set to either “Total Energy Saved” or “Total Savings,” both in United States Dollars. Preferably, this information can be input into a keypad provided with the device 120.

Once the values have been input into the device 120 in step 200, and the refrigeration system is enabled, in step 210 the device 120 measures parameters, such as the ECWT or other values relating to operating performance. Preferably, the ECWT, in degrees Fahrenheit, is obtained from an analog input channel using a sensing device, such as a thermistor. This information, and other information may be provided directly to the device 120, or obtained from the control panel 40. Additionally, in step 210, the input VSD kW data from the VSD, or through the control panel 40, or an optional harmonic filter, is provided to the device 120 at predetermined time periods, such as every two seconds, since the input VSD kW data is subject to change in response to the cooling load as determined by the control panel 40.

After parameters have been measured, values are calculated in step 220 and stored in step 230. The stored values include not only the calculated values in step 220, but may also include measured parameters in step 210. A number of the values calculated in step 220 which are included below, are summarized by subject matter, and include a discussion of measuring, calculating and storing steps. The value summarizations are not separated into steps 210, 220 and 230, both for convenience and since it is apparent which portions of the values discussed pertain to the respective steps.

Hourly Average Return Condenser Liquid Temperature (×24 Hours)

The Return Condenser Liquid Temperature is preferably read every second, and added to a sum. After 3600 seconds, the sum is divided by 3600 to obtain the average for the past hour, then the sum is cleared. The averages for the past 24 hours are preferably scrolled using a first in first out (“FIFO”) scheme, with the most recently calculated average being preferably stored in a first array position. These values are preferably stored in erasable random access memory (“RAM”), such as battery-backed RAM or BRAM, including a running sum, a data index point, and a Julian time of the last data point.

Daily Average Return Condenser Liquid Temperature (×30 Days)

The Hourly Average Return Condenser Liquid Temperature is preferably read every hour, and added to a sum. After 24 hours, the sum is preferably divided by 24 to obtain the average for the previous day, then the sum is cleared. The averages for the past 30 days are preferably scrolled using a FIFO scheme, and the latest computed average is preferably stored in a first array position. These values are preferably stored in memory including the running sum, the data index point, and the Julian time of the last data point.

Monthly Average Return Condenser Liquid Temperature (×12 months).

The Daily Average Return Condenser Liquid Temperature is preferably read every day, and added to a sum. After 30 days, the sum is preferably divided by 30 to obtain the average for the past month, then the sum is preferably cleared. The averages for the past 12 months are preferably scrolled using a FIFO scheme, and the latest average just computed are preferably stored in the first array position. These values are preferably stored in memory including the nming sum, the data index point, and the Julian time of the last data point.

Yearly Average Return Condenser Liquid Temperature (×20 Years)

The Monthly Average Return Condenser Liquid Temperature is preferably read every month, and added to a sum. After 12 months, the sum is preferably divided by 12 to obtain the average for the past year, then the sum is preferably cleared. The averages for the past 20 years are preferably scrolled using a FIFO scheme, and the latest computed average is preferably stored in the first array position. These values are preferably stored in memory including the running sum, the data index point, and the Julian time of the last data point.

Hourly Minimum Return Condenser Liquid Temperature (×24 Hours)

The Return Condenser Liquid Temperature is preferably read every second, and compared to the last minimum value. If it is less than the last minimum value, the last minimum value is preferably set to the current temperature reading. The minimums for the past 24 hours are preferably scrolled using a FIFO scheme, and the latest minimum evaluated is preferably stored in the first array position. These values are preferably stored in memory, including the Julian time of the last data point.

Daily Minimum Return Condenser Liquid Temperature (×30 Days)

When the calendar day changes, the last 24 Hourly Minimum Return Condenser Liquid Temperatures is examined for the minimum value for that day. The minimums for the past 30 days is preferably scrolled using a FIFO scheme, and the latest minimum evaluated is preferably stored in the first array position. These values are preferably stored in memory, including the Julian time of the last data point.

Monthly Minimum Return Condenser Liquid Temperature (×12 Months)

When the calendar month changes, the last 30 Daily Minimum Return Condenser Liquid Temperatures is examined for the minimum value for that month. The minimums for the past 12 months are preferably scrolled using a FIFO scheme, and the latest minimum evaluated is preferably stored in the first array position. These values are preferably stored in memory, including the Julian time of the last data point.

Yearly Minimum Return Condenser Liquid Temperature (×20 Years)

When the calendar year changes, the last 12 Monthly Minimum Return Condenser Liquid Temperatures are examined for the minimum value for that year. The minimums for the past 20 years are preferably scrolled using a FIFO scheme, and the latest minimum evaluated are preferably stored in the first array position. These values are preferably stored in memory, including the Julian time of the last data point.

VSD kW-hr Meter

This calculation can be performed as follows: the VSD kW is transmitted from the VSD to the control panel once very two seconds. This value is added to the VSD kW Total. When this sum exceeds 1800 (3600 seconds per hour/2 seconds per reading), since 1800 kW equals 1 kW-hr, the VSD kW-hr Meter is incremented by one, and 1800 is subtracted from the VSD kW Total that corresponds to a partial kW-hr, which re-sets the partial kW-hr component of the VSD kW-hr Meter. The value of the VSD KW-hr Meter can be modified if the access level is properly set. Both the VSD KW-hr Meter and the VSD kW Total are preferably stored in memory.

CSD kW-hr Meter

Every two seconds, while the chiller is running, the VSD kW is divided by the VSD design kW to get VSD % design kW. Using the ECWT and the equation, the CSD % design kW is determined. This is preferably multiplied by the CSD design kW to obtain the CSD kW. The CSD kW value is preferably added to the CSD kW Total. When this sum exceeds 1800 (3600 seconds per hour/2 seconds per reading), since 1800 kW equals 1 kW-hr, the CSD KW-hr Meter is preferably incremented by one, and 1800 is preferably subtracted from the CSD kW Total that corresponds to a partial kW-hr, which re-sets the partial kW-hr component of the CSD kW-hr Meter. The value of the CSD kW-hr meter can be modified if the access level is properly set. Both the CSD kW-hr Meter and the CSD kW Total are preferably stored in memory.

Total Saved Energy

Every two seconds, while the chiller is running, using the transmitted VSD kW and the calculated CSD kW, the energy saved is preferably calculated by subtracting the VSD kW from the CSD kW. This value is then added to the Saved kW Total. When this sum exceeds 1800 (3600 seconds per hour/2 seconds per reading), since 1800 kW equals 1 kW-hr, the Total Saved Energy (kW-hr) is preferably incremented by one, and 1800 is preferably subtracted from the Saved kW Total that corresponds to a partial kW-hr, which re-sets the partial kW-hr component of the VSD kW-hr Meter. The value of the Total Saved Energy can be modified if the access level is properly set. Both the Total Saved Energy and the Saved kW Total are preferably stored in memory.

Hourly Total Saved Energy (×24 Hours)

The Total Saved Energy is preferably read every hour. The reading taken one hour ago is subtracted from the most recent reading to determine the present hourly value. The hourly values for the past 24 hours is preferably scrolled using a FIFO scheme, and the latest hourly value most recently computed are preferably stored in the first array position. These values are preferably stored in memory, including the running sum, the data index point, and the Julian time of the last data point.

Daily Total Saved Energy (×30 Days)

The Total Saved Energy is preferably read at midnight of every day. The reading taken one day ago is subtracted from the most recent reading just taken to determine the present daily value. The daily values for the past 30 days are preferably scrolled using a FIFO scheme, and the latest daily value just computed is preferably stored in the first array position. These values is preferably stored in memory including the running sum, the data index point, and the Julian time of the last data point.

Monthly Total Saved Energy (×12 Months)

The Total Saved Energy is preferably read at midnight of the last day of every month. The reading taken one month ago is subtracted from the most recent reading to determine the present monthly value. The monthly values for the past 12 months are preferably scrolled using a FIFO scheme, and the latest monthly value just computed is preferably stored in the first array position. These values are preferably stored in memory including the running sum, the data index point, and the Julian time of the last data point. The actual meter reading at the end of each month is also be stored.

Yearly Total Saved Energy (×20 Years)

The Total Saved Energy is preferably read at midnight of the last day of every year. The reading taken one year ago is preferably subtracted from the most recent reading to determine the present yearly value. The yearly values for the past 20 years is preferably scrolled using a FIFO scheme, and the latest yearly value most recently computed is preferably stored in the first array position. These values are preferably stored in memory including the running sum, the data index point, and the Julian time of the last data point.

Total Savings in United States Dollars

The Total Saved Energy is preferably multiplied by the Cost Per kW-hr to compute the Total Savings in United States Dollars.

After the values and parameters have been stored in step 230, values, such as those previously identified above, and preferably those relating to savings, can be output to a display which is included with the device 120.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for comparing costs associated with operating a refrigeration system using a variable speed drive versus a constant speed drive, the method comprising the steps of:
providing a refrigeration system using a variable speed drive;
providing an equation to calculate operating cost of the refrigeration system using a constant speed drive, the equation incorporating at least one operating parameter of the refrigeration system;
measuring the at least one operating parameter of the refrigeration system;
determining a cost associated with operation of the refrigeration system using the variable speed drive;
calculating a cost associated with operation of the refrigeration system using the constant speed drive using the equation and the measured at least one operating parameter; and
comparing the cost associated with operating the refrigeration system using the variable speed drive with the cost associated with operating the refrigeration system using the constant speed drive.

2. The method of claim 1 wherein the step of providing an equation includes inputting values associated with operation of the refrigeration system.

3. The method of claim 1 wherein the step of calculating a cost further includes the step of:
determining an amount of energy required by the variable speed drive to operate the refrigeration system for a predetermined time.

4. The method of claim 1 wherein the step of calculating a cost further includes the step of:
calculating a ratio based on the amount of energy required by the variable speed drive divided by a predetermined amount of energy required for the variable speed drive.

5. The method of claim 1 wherein the at least one measured operating parameter is at least one parameter selected from the group consisting of temperature of a fluid entering a condenser, temperature of a fluid leaving a condenser, saturated condensing temperature and temperature differential between evaporator temperature and condenser temperature.

6. The method of claim 1 further including the steps of:
repeating the step of comparing the cost associated with operating the refrigeration system using the variable speed drive with the cost associated with operating the refrigeration system using the constant speed drive at a predetermined time interval for a predetermined time duration; and
storing results of repeated cost comparisons.

7. The method of claim 1 wherein the step of providing an equation includes providing a polynomial.

8. The method of claim 1 wherein the step of providing an equation includes providing a polynomial in the form
C1+(C2×X)+(C3×2)+(C4×Y)+(C5×X×Y)+(C6×X2×Y)+(C7×Y2)+(C8×X×Y2)+(C9×X2×Y²), wherein C1 through C9 are constants, X is a ratio of VSD input kW to VSD design kW and Y is the at least one measured operating parameter.

9. The method of claim 1 wherein the at least one measured operating parameter is at least one parameter selected from the group consisting of temperature of a fluid entering a condenser, temperature of a fluid leaving a condenser, saturated condensing temperature and temperature differential between evaporator temperature and condenser temperature.

10. The method of claim 8 wherein the step of providing an equation includes determining constants C1 through C9 of the polynomial in response to a refrigerant used in the refrigeration system.

11. The method of claim 8 wherein the step of providing an equation includes determining constants C1 through C9 of the polynomial in response to a condenser fluid used in the refrigeration system.

12. The method of claim 8 wherein the step of providing an equation includes determining constants C1 through C9 of the polynomial in response to an evaporator fluid used in the refrigeration system.

13. The method of claim 12 wherein the evaporator fluids are selected from the group consisting of water, ethylene glycol, propylene glycol, calcium chloride brine and sodium chloride brine.

14. The method of claim 8 wherein the step of providing an equation includes determining constants C1 through C9 of the polynomial in response to a type of positive displacement compressor used in the refrigeration system.

15. A refrigeration system comprising:
a refrigeration circuit having a compressor driven by a motor, a condenser and an evaporator connected in a closed loop;
a variable speed drive to drive the compressor motor;
a computer system, the computer system comparing a microprocessor and a memory device to store an equation calculating operating cost of the refrigeration circuit using a constant speed drive, the equation incorporating at least one measured operating parameter of the refrigeration circuit;
at least one sensor to measure the at least one operating parameter of the refrigeration circuit; and
wherein the computer system being configured to determine an amount of energy required by the variable speed drive using the refrigeration circuit for a predetermined time, determining a first cost associated with operating the refrigeration circuit using the variable speed drive, and calculating a first ratio based on the amount of energy required by the variable speed drive divided by a predetermined amount of energy required by the variable speed drive, the computer system solving the equation using the first ratio and the at least one operating parameter to obtain a second ratio being based on the amount of energy required by the constant speed drive divided by a predetermined amount of energy required by the constant speed drive, the computer system calculating a cost associated with operation of the refrigeration circuit using the constant speed drive.

16. The refrigeration system of claim 15 wherein the computer system repeatedly compares the cost associated with operating the refrigeration circuit using the variable speed drive with the cost associated with operating the refrigeration circuit using the constant speed drive and stores results of comparisons.

17. The refrigeration system of claim 15 wherein the measured parameter is selected from the group consisting of temperature of a fluid entering a condenser, temperature of a fluid leaving a condenser, saturated condensing temperature and temperature differential between an evaporator temperature and condenser temperature.

18. The refrigeration system of claim 15 wherein the equation is a polynomial.

19. The refrigeration system of claim 18 wherein the polynomial is in the form
C1+(C2×X)+(C3×X2)+(C4×Y)+(C5×X×Y)+(C6×X2×Y)+(C7×Y2)+(C8×X×Y2)+(C9×X2×Y2), wherein C1 through C9 are constants, X is a ratio of VSD input kW to VSD design kW and Y is the at least one measured operating parameter.

20. The refrigeration system of claim 15 wherein the at least one measured operating parameter is selected from the group consisting of temperature of a fluid entering a condenser, temperature of a fluid leaving a condenser, saturated condensing temperature and temperature differential between an evaporator temperature and condenser temperature.

21. The refrigeration system of claim 19 wherein the constants C1 through C9 of the polynomial are determined in response to the refrigerant system using different refrigerants.

22. The refrigeration system of claim 19 wherein the constants C1 through C9 of the polynomial are determined in response to the refrigerant system using different condenser fluids.

23. The refrigeration system of claim 19 wherein the constants C1 through C9 of the polynomial are determined in response to the refrigerant system using a different type of positive displacement compressor.

24. The refrigeration system of claim 19 wherein the constants C1 through C9 of the polynomial are determined in response to the refrigerant system using different evaporator fluids.

25. The refrigeration system of claim 24 wherein the evaporator fluids are selected from the group consisting of water, ethylene glycol, propylene glycol, calcium chloride brine and sodium chloride brine.
